(19) United States
(12) Patent Application Publication
(10) Pub. No.: US 2023/0052708 A1
(43) Pub. Date: Feb. 16, 2023

(54) NON-REWETTING O/W (OIL IN WATER) EMULSIFICATION SYSTEM FOR HYDROPHOBIC COMPOUNDS

(71) Applicant: ORGANOCLICK AB, Täby (SE)

(72) Inventors: Juhanes AYDIN, Södertälje (SE); Salman HASSANZADEH, Vallentuna (SE)

(21) Appl. No.: 17/782,701

(22) PCT Filed: Dec. 14, 2020
(86) PCT No.: PCT/SE2020/051209

§ 371 Date: Jun. 6, 2022

(30) Foreign Application Priority Data
Dec. 13, 2019 (SE) 1951453-8

(51) Int. Cl. C09K 23/00; C09K 23/22; C09K 23/16; D06M 13/402; D06M 13/332; D06M 13/02; D06M 13/342; D06M 15/05; D06M 15/59; D06M 15/11; D06M 15/61

(52) U.S. Cl. CPC C09K 23/017; C09K 23/16; C09K 23/22; D06M 13/02; D06M 13/332; D06M 13/342; D06M 13/402; D06M 15/05; D06M 15/11; D06M 15/59; D06M 15/61; D06M 2101/32

(57) ABSTRACT

An emulsified liquid composition is disclosed comprising a hydrophobic phase, an emulsifying composition of a protonated amide and a protonated amine having defined carbon to nitrogen atom molar ratios and water. The compositions optionally comprise at least one of a defoamer, a coalescent agent, a preservative, a co-emulsifier, chain extender, crosslinker and a rheology modifier. The compositions are useful for application to induce hydrophobicity to inorganic, organic or fiber based materials without undesirable backwetting or re-wetting effects.

### TECHNICAL FIELD

The present invention generally relates to a new emulsifying system comprising a combination of an organic amide, an organic amine and an acid, and an improved method for obtaining enhanced hydrophobicity of inorganic, organic or fiber based materials by different application methods and broad activation temperatures with a good washing and/or weathering-durability.

### BACKGROUND OF THE INVENTION

One of the main challenges in the emulsification of hydrophobic chemicals is to find a dispersive /emulsifying/surface active agent which does not cause rewetting of the treated material after application of the emulsion on the surface of the different materials (inorganic, organic or fiber based materials). While traditional surfactants can be used for emulsifying a hydrophobic agent in a water borne formulation, their interference with the final expected material surface properties due to their intervention in the final surface properties of the treated material in terms of back wetting, reduce the actual performance of the hydrophobizing agent used in the emulsion. Different non wetting emulsifying systems have been introduced to the market, for example, using thermolabile surfactants with controlled lifetime (Commercially available amine oxide surfactants) such as Cetapol OX20 (Avocet Dyes Ltd) or volatile surfactants such as Surfynol 61 (Air Products)). However, the use of these systems is limited due to their inability to provide strong surface active properties at low usage levels, their requirement for long periods of heating (thermolabile surfactants) and usage safety among other problems.

The Swedish patent application 1651195-8 discloses an emulsion for hydrophobizing fibrous materials with hydrophobic agents employing selected aminosiloxanes that will act as a provisional emulsifier while in protonated form in the presence of an acid, but will subsequently lose their surface activity when introduced into a network with the fibers, so the problem of back wetting is eliminated. Despite this there is a need for a new emulsifying system for hydrophobization of materials without back wetting or rewetting that admits curing at low temperatures and admits low usage level of emulsifiers and allows a broad range of hydrophobic agents to be emulsified such as oils, waxes, and silanes and similar. At the same time, the organic base of the new emulsifying system according to the present invention, compared to aminosiloxane based emulsifying system, would pave a way to use bio-based materials from renewable resources and hence lead to a more sustainable product portfolio.

Emulsifying compositions have previously been suggested as means to enhance hydrophobicity of fibre materials, see for instance US 3374100 A.

### OBJECTS OF THE INVENTION

It is an object of the invention to provide new emulsifying compositions comprising a combination of an organic amide, an organic amine and an acid capable of emulsifying a broad range of hydrophobic compounds.

It is also an object of the invention to provide improved application methods to obtain enhanced hydrophobicity, a water repellency durable to weathering and washing and a repellency against water soluble dirt on inorganic, organic or fiber based materials allowing the usage of a broad range of activation temperatures.

It is also an object of the invention to provide cost-effective applications that result in immediate hydrophobicity or the treated materials with an emulsion that is dilutable in water, and is stable both in concentrated and highly diluted form (1:30), thereby enabling efficient add-on control on the treated material.

It is also an object of the invention to avoid back-wetting or re-wetting of the applied material, which may result from conventional surfactants (emulsifiers) on the material surface with the consequence that an extra cleaning step is required for the material to induce correct hydrophobicity.

It is another object of the invention to provide means to use a non-rewetting emulsifying composition with an organic structure which can be potentially produced from renewable sources.

A further object of the invention is to provide means to use known industrially used methods and the chemical emulsion composition, for example in the current production methods of inorganic, organic or fiber based materials, such as textile, non-woven, wood, paper, glass, glass fiber, stone, brick, and the like.

Further objects of the invention are to provide a chemical emulsion composition for application with low viscosity, such as below 100 mPas, broad temperature interval for drying and curing, which causes no or very low yellowing of the treated material, immediately enhances hydrophobicity and water based dirt repellency, as well as a soft hand on relevant materials such as textiles, whilst avoiding the use of fluorocarbons.

A further object of the invention is to provide a chemical emulsion composition for application, which allows for simple manipulations, through the addition or partly substitution of one or more of the compounds of the chemical composition of the invention using said optional co-emulsifier, catalyst, preservative, rheology modifier or mixtures thereof to adjust the properties and effects of the composition on the treated material, and to further adjust the drying and curing times and temperatures.

Still further objects of the invention are to provide chemical emulsion compositions which induce highly durable hydrophobicity for different material, having immediate effects following the application, having good shelf life and with minimal adverse environmental effect when washed/leached out.

A further object of the invention is to avoid or strongly minimize the use of surface active agents/emulsifiers/surfactants which negatively affect the final hydrophobic properties of the treated material and which might have adverse effect on the environment when washed/leached out.

These and other objects, features and advantages of the herein described invention will become more apparent from the following detailed description thereof.

### GENERAL DESCRIPTION OF THE INVENTION

In a first general aspect, the present invention relates to an emulsifying composition comprising:
a) at least one positively charged organic amide selected from at least one of a polymeric amide and an amide according to the general formula I:

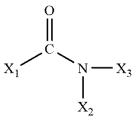

Formula I wherein X1, X2 and X3 are same or different groups and a polymeric amide, so that the molar ratio of carbon atoms to nitrogen atoms of said at least one amide is 70≥C/N≥3, preferably 60≥C/N≥5, and more preferably 50≥C/N≥6, wherein the amide according to the general Formula I is selected from primary, secondary and tertiary amides of saturated or unsaturated, branched or linear acid(s) with total carbon of less than 150 of carbon atoms, and wherein the amide according to the general Formula I is selected from primary, secondary or tertiary amides of saturated or unsaturated, branched or linear acids which are not water soluble at a pH of 1 to 7; and
b) at least one positively charged organic amine selected from at least one of a polymeric amine and an amine according to the general formula II below:

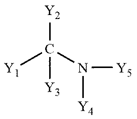

wherein Y1, Y2, Y3, Y4 and Y5 are same or different groups, so that the molar ratio of carbon atoms to nitrogen atoms of said at least one amine is 70≥C/N≥3, preferably 60≥C/N≥5, and more preferably 50≥C/N≥6, and wherein the amine according to the general Formula II is selected from primary, secondary or tertiary amine with total carbon of less than 150 carbon atoms, wherein the amine according to the general Formula II is not water soluble at a pH of 1 to 7, and wherein the amine is selected from primary, secondary or tertiary amines with saturated or unsaturated, branched or linear hydrocarbons chains or wherein the amine is an amine derived from saturated or unsaturated, branched or linear acids; and
at least one Lewis acid and/or at least one Brönsted acid selected from Lewis acid from groups 2, 4, 8, 12 and 13 in the periodic table of elements and Brönsted acids with a pKa of < 7.

It has surprisingly been found that by using an emulsifying composition comprising water insoluble amides and amines according to the present invention, improved interaction between the emulsifying composition and a hydrophobic agent is achieved. This improved interaction results in the emulsifying composition exhibiting improved dispersion, i.e. stability, of the oil-in-water system. As a result, the emulsifying composition is able to better distribute a hydrophobic agent on a fibre-based material. Without being bound to theory, it is believed that a non-water-soluble emulsifying composition is able to better support the hydrophobicity phase to assemble to a treated fibre based material, thus resulting in a more persistent water-repellency and reduced rewetting.

In one aspect of the emulsifying composition the groups X1 to X3 and Y1 to Y5 of the amide and the amine are hydrogen or saturated or unsaturated hydrocarbon chains, which are unsubstituted or substituted, and straight or branched.

In one aspect, the amide is selected from the primary, secondary and tertiary amides of saturated or unsaturated, branched or linear carboxylic acid with 40 or less carbon atoms (C≤40), such as methanoic acid, ethanoic acid, ethanedioic acid, oxoethanoic acid, 2-hydroxyethanoic acid, propanoic acid, prop-2-enoic acid, 2-propynoic acid, propanedioic acid, 2-hydroxypropanedioic acid, oxopropanedioic acid, 2,2-dihydroxypropanedioic acid, 2-oxopropanoic acid, 2-hydroxypropanoic acid, 3-hydroxypropanoic acid, 2,3-dihydroxypropanoic acid, 2-oxiranecarboxylic acid, butanoic acid, 2-methylpropanoic acid, 2-oxobutanoic acid, 3-oxobutanoic acid, 4-oxobutanoic acid, (E)-butenedioic acid, (Z)-butenedioic acid, But-2-ynedioic acid, oxobutanedioic acid, hydroxybutanedioic acid, 2,3-dihydroxybutanedioic acid, (E)-but-2-enoic acid, pentanoic acid, 3-methylbutanoic acid, pentanedioic acid, 2-oxopentanedioic acid, 3-oxopentanedioic acid, furan-2-carboxylic acid, tetrahydro-2-furancarboxylic acid, hexanoic acid, hexanedioic acid, 2-hydroxypropane-1,2,3-tricarboxylic acid, prop-1-ene-1,2,3-tricarboxylic acid, 1-hydroxypropane-1,2,3-tricarboxylic acid, (2E,4E)-hexa-2,4-dienoic acid, heptanoic acid, heptanedioic acid, cyclohexanecarboxylic acid, benzenecarboxylic acid, 2-hydroxybenzoic acid, octanoic acid, benzene-1,2-dicarboxylic acid, nonanoic acid, benzene-1,3,5-tricarboxylic acid, (E)-3-phenylprop-2-enoic acid, decanoic acid, decanedioic acid, undecanoic acid, dodecanoic acid, benzene-1,2,3,4,5,6-hexacarboxylic acid, tridecanoic acid, tetradecanoic acid, pentadecanoic acid, hexadecanoic acid, heptadecanoic acid, octadecanoic acid, (9Z)-octadec-9-enoic acid, (9Z,12Z)-octadeca-9,12-dienoic acid, (9Z,12Z,15Z)-octadeca-9,12,15-trienoic acid, (6Z,9Z,12Z)-octadeca-6,9,12-trienoic acid, (6Z,9Z,12Z,15Z)-octadeca-6,9,12,15-tetraenoic acid, nonadecanoic acid, eicosanoic acid, (5Z,8Z,11Z)-eicosa-5,8,11-trienoic acid, (5Z,8Z,11Z,14Z)-eicosa-5,8,11,14-tetraenoic acid, heneicosanoic acid, docosanoic acid, (4Z,7Z,10Z,13Z,16Z,19Z)-docosa-4,7,10,13,16,19-hexaenoic acid, tricosanoic acid, tetracosanoic acid, pentacosanoic acid, hexacosanoic acid, Carboceric acid, Montanic acid, Nonacosylic acid, Melissic acid, Hentriacontylic acid, Lacceroic acid, Psyllic acid, Geddic acid, Ceroplastic acid, Hexatriacontylic acid, Heptatriacontylic acid, Octatriacontylic acid, Nonatriacontylic acid, Tetracontylic acid, Myristoleic, Palmitoleic acid, Sapienic acid, Oleic acid, Elaidic acid, Vaccenic acid, Gadoleic acid, Eicosenoic acid, Erucic acid, Nervonic acid, Linoleic acid, Eicosadienoic acid, Docosadienoic acid, Tri-unsaturated fatty acids, Linolenic acid, Pinolenic acid, Eleostearic acid, Mead acid, Dihomo-γ-linolenic acid, Eicosatrienoic acid, Stearidonic acid, Arachidonic acid, Eicosatetraenoic acid, Adrenic acid, Pentaunsaturated fatty acids, Bosseopentaenoic acid, Eicosapentaenoic acid, Ozubondo acid, Sardine acid, Tetracosanolpentaenoic acid, Hexa-unsaturated fatty acids, Cervonic acid, Herring acid, ethanedioic acid, propanedioic acid, butanedioic acid, pentanedioic acid, hexanedioic acid, heptanedioic acid, octanedioic acid, nonanedioic acid, decanedioic acid, undecanedioic acid, dodecanedioic acid, tridecanedioic acid, hexadecanedioic acid, heneicosa-1,21-dioic acid, docosanedioic acid, triacontanedioic acid, (Z)-Butenedioic acid, (E)-Butenedioic acid, But-2-ynedioic acid, (Z)-Pent-2-enedioic acid, (E)-Pent-2-enedioic acid, 2-Decenedioic acid, Dodec-2-enedioic acid, Muconic acid, Glutinic acid, Citraconic acid, Mesaconic acid, Itaconic acid, 2-Hydroxypropanedioic acid, Oxopropanedioic acid, Hydroxybutanedioic acid, 2,3-Dihydroxybutanedioic acid, Oxobutanedioic acid, 2-Aminobutanedioic acid, 2-hydroxypentanedioic acid, 2,3,4-Trihydroxypentanedioic acid, 3-Oxopentanedioic acid, 2-Oxopentanedioic acid, 2-Aminopentanedioic acid, (2R,6S)-2,6-Diaminoheptanedioic acid, (2S,3S,4S,5R)-2,3,4,5-Tetrahydroxyhexanedioic acid, Benzene-1,2-dicarboxylic acid, Benzene-1,3-dicarboxylic acid, Benzene-1,4-dicarboxylic acid, 2-(2-Carboxyphenyl)benzoic acid, 2,6-Naphthalenedicarboxylic acid, pyruvic acid, oxaloacetic acid, acetoacetic acid, levulinic acid, benzoic acid, salicylic acid, ω-phenylalkanoic acid (x = 1 to 17), Bicyclic hexahydroindenoic acid, Crassinervic acid, glyceric acid, glycolic acid, lactic acid tartaric acid and Divinylether fatty acids.

In one aspect of the inventive emulsifying compositions, the amide is a polymeric amide which has a molecular weight of 1 kDa≤Mw≤1000 kDa, preferably of 2 kDa≤Mw≤500 kDa.

In one aspect of the inventive emulsifying compositions, the amide is a polymeric amide selected from amidated polycarbohydrate such as amidated starch (amylose, amylopectine), cellulose, gums, chitosan and derivatives thereof, polypeptides, polynucleic acids and aliphatic polyamides such as Nylon 6, Nylon 6/6, Nylon 6/12, Nylon 11, Nylon 12 and polyphthalamides or other aromatic polyamides.

In one aspect of the inventive emulsifying compositions, the amine is an amino acid with a solubility of less than 20 g/100 mL in water at 25° C., preferably selected from at least one of Isoleucine, Tryptophan, Tyrosine, Leucine, Phenylalanine, Asparagine, Aspartic Acid, Glutamic Acid, Glutamine, Histidine, Methionine, Serine and Valine.

In one aspect of the inventive emulsifying compositions, the amine is a polymeric amine which has a molecular weight of 1 kDa≤Mw≤1000 kDa, preferably 2 kDa≤Mw≤500 kDa.

In one aspect of the inventive emulsifying compositions, the amine is a polymeric amine selected from at least one of aminated polycarbohydrate such as aminated starch (amylose, amylopectine), cellulose, gums, chitosan and derivatives thereof, polypeptides, polynucleic acid, poly(vinylpyridine), poly(vinylpyrrolidone), poly(vinylamine) and the salts, poly(L-lysine)and the salts, polyethylenimine and the salts, poly(allylamine) and the salts, poly(4-aminostyrene, poly(N-methylvinylamine), poly(diallyldimethyl) and the salts, poly(2-vinyl-1-methylpyridin) and the salts, Poly(N,N-dimethylaminoethyl methacrylate) [I], poly(N,N-dimethylaminoethylacrylate-co-methylmethacrylate) [II] and poly(N,N-dimethylaminopropylacrylamide-co-methylmethacrylate) and polyoxypropylenediaminein.

In one aspect of the inventive emulsifying compositions, the amide comprises a primary amide according to formula I above, wherein X2 and X3 are hydrogen atoms and X1 contains less than 40 carbon atoms, wherein the carbon to nitrogen molar ratio is 40≥C/N≥6, and wherein said primary amide is not water soluble at a pH of 1 to 7, preferably said primary amide is selected from at least one of Erucamide, Oleamide, Behenamide, Stearamide, Palmitamide, Lauramide, 12-Hydroxystearamide and similar amides.

In one aspect of the inventive emulsifying compositions, at least one amide is a secondary organic amide according to formula I above, wherein X2 is a hydrogen atom and X1 and X3 contain less than 40 carbon atoms each, wherein the carbon to nitrogen molar ratio of said secondary amide is 40≥C/N≥6 and, wherein said secondary amide is not water soluble at a pH of 1 to 7, preferably said amide is selected from at least one of N-Stearyl stearamide, N-Stearyl oleamide, N-Oleyl stearamide, N-Stearyl erucamide, N-Methylolstearamide, Methylenebis stearamide, Ethylenebis capramide, Ethylenebis stearamide, Ethylenebis 12-hydroxystearamide, Ethylenebis behenamide, Hexamethylenebis stearamide, Hexamethylenebis behenamide, Hexamehylenebis 12-hydroxystearamide, N,N′-Distearyl adipamide, Ethylenebis oleamide, Hexamethylenebis oleamide, N,N′-Dioleyl adipamide, Oleyl Palmitamide, Stearyl Erucamide, Ethylene bis-Olemide and similar amides.

In one aspect of the inventive emulsifying compositions, at least one amide is a tertiary organic amide according to formula I wherein X1, X2 and X3 contain less than 40 carbon atoms each, wherein the carbon to nitrogen molar ratio of said tertiary amide is 40≥C/N≥ 6 and wherein said tertiary amide is not water soluble at a pH of 1 to 7, preferably said amide is selected from at least one of N,N-Dimethyloleamide, N,N-Diethyl oleamide, Octadecanamide, N,N-bis(2-hydroxyethyl), N,N-Dimethylstearamide, N,N-bis(2-hydroxyethyl)stearamide, N,N-bis(2-hydroxyethyl)hexadecan-1-amide, N,N-bis(2-hydroxyethyl)oleamide, N,N-Bis(2-hydroxyethyl)dodecanamide and similar amides.

In one aspect of the inventive emulsifying compositions, at least one amine is a primary organic amine according to formula II above, wherein Y4 and Y5 are hydrogen atoms and Y1, Y2 and Y3 contain less than 50 carbon atoms each and wherein the primary amine has a carbon to nitrogen molar ratio of 40≥C/N≥6 and is not water soluble at a pH of 1 to 7, preferably said primary amine is selected from at least one of coco amine, oleylamine, tallow amine, soya amine, Stearyl amine, (12E,15E)-N-[(21E,24E)-hexatriaconta-21,24-dienyl]hexatriaconta-12,15-dien-1-amine, Dodecylamine and similar primary amines.

In one aspect of the inventive emulsifying compositions, at least one amine is a secondary organic amine according to formula II above, wherein Y5 is a hydrogen atom and Y1, Y2, Y3 and Y4 contain less than 50 carbon atoms each, wherein said secondary amine has a carbon to nitrogen molar ratio of 40≥C/N≥6 and is not water soluble at a pH of 1 to 7 preferably said secondary amine is selected from at least one of Dioleyl amine, Dioctadecylamine, (12E,15E)-N-[(21E,24E)-hexatriaconta-21,24-dienyl]hexatriaconta-12,15-dien-1-amine and similar secondary amines.

In one aspect of the inventive emulsifying compositions, at least one amine is a tertiary organic amine according to formula II in claim 1, wherein Y1, Y2, Y3, Y4 and Y5 contain less than 50 carbon atoms each, wherein said tertiary organic amine has a carbon to nitrogen molar ratio of 40≥C/N≥6 and is not water soluble at a pH 1 of 7 preferably said tertiary amine is selected from at least one of:N-[3-(dimethylamino)propyl]dodecanamide, N-[3(Dimethylamino)propyl]myristamide, N-[3(dimethylamino)propyl]hexadecanamide, N-[3-(dimethylamino)propyl]octadecanamide, N-[3(dimethylamino)propyl]octadec-9-enamide,(9Z,12Z)-N-[3-(dimethylamino)propyl]octadeca-9,12-dienamide (linoleamide), (9Z,12Z,15Z)-N-[3-(dimethylamino)propyl]octadeca-9,12,15-trienamide (linolenamide) and N-[3-(dimethylamino)propyl]eicosanamide and similar tertiary amines.

In one aspect of the inventive emulsifying compositions, at least one amine is a dimer diamine, preferably a fatty dimer diamine with less than 50 carbon atoms, more preferably (12E,15E)-N-[(21E,24E)-hexatriaconta-21,24-dienyl]hexatriaconta-12,15-dien-1-amine and similar dimer diamines.

In one aspect of the inventive emulsifying compositions, at least one amide is synthesized from a fatty acid with less than 50 carbon atoms, preferably oleyol palmitamide or stearyl erucamide, and the amine is a dimer diamine, preferably a fatty dimer diamine with less than 50 carbon atoms, more preferably (12E,15E)-N-[(21E,24E)-hexatriaconta-21,24-dienyl]hexatriaconta-12,15-dien-1-amine and similar.

In one aspect of the inventive emulsifying compositions, at least one amide is synthesized from a fatty acid with less than 50 carbon atoms, preferably oleyol palmitamide or stearyl erucamide, and the organic amine is an amino acid according to what was defined above and/or a polymeric amine according to what was defined above, preferably the polymeric organic amine is selected from biopolymers having amino groups, more preferably the polymeric organic amine is chitosan.

In one aspect of the inventive emulsifying compositions, it further comprises a Lewis acid, selected from a salt solution of a Group 4 or group 13 metal salt and the mixture thereof, preferably Zirconium based salts, and more preferably Zirconium acetate and/or Zirconium acetate hydroxide.

In another general aspect, the present invention is directed to an emulsified liquid composition comprising: a) a hydrophobic phase comprising one or more hydrophobic agents; b) an emulsifying composition according to any previously mentioned aspect thereby including at least one positively charged amide and at least on positively charged amine proving a positively charged emulsifier; c) water; and d) optionally at least one of a defoamer, a coalescent agent, a preservative, a co-emulsifier, chain extender, crosslinker and a rheology modifier

In another general aspect, the present invention is directed to an emulsified liquid composition comprising a) 0.01 to 50 wt%, preferably 0.05 to 45 wt%, more preferably 0.1 to 40 wt%, even more preferably 0.2 to 30 wt% of the hydrophobic phase; b) 0.01 to 12 wt%, preferably 0.05 to 10 wt%, more preferably 0.1 to 8 wt% of the positively charged emulsifying composition; and c) 38 to 99.98 wt% of water.

Preferably, emulsified liquid compositions have a pH of 1 to 7 and more preferably of 2 to 6.

In another aspect, the present invention is directed to an emulsified liquid composition with a hydrophobic phase comprising one or more hydrophobic agents which are independently of each other selected from the group consisting of natural oil, synthetic oil, natural wax, synthetic waxes, liquid resin, fatty acid, fatty alcohol, fatty silane, fatty siloxane, fatty epoxide, fatty imine, fatty aldehyde, fatty imide, fatty thiol, fatty sulfate, fatty ester, fatty ketone, other types of lipids, preferably selected from natural oil, natural wax, fatty silanes and/or fatty acid, and mixtures thereof.

The emulsified liquid compositions preferably comprises a mixture of at least one organic amide and at least one organic amine (both as defined in the previous aspects) in the composition in the range of 0.01 to 20 wt%, preferably of 0.05 to 15 wt%, more preferably of 0.1 to 10 wt% and most preferably of 0.2 to 8 wt%, in order to provide excellent hydrophobicity and composition stability (during the material modification process).

In another aspect, the present invention is directed to an emulsified liquid composition comprising an acid-catalyst, preferably with a pKa of less than 7, more preferably with pKa of 1.5 to 6, most preferably with a pKa of 1.9 to 4.9.

In another aspect, the present invention is directed to an emulsified liquid composition comprising an acid-catalyst that is a Lewis acid comprising at least one polyvalent metal salt, selected from at least one of: zirconium acetate, zirconium propionate, zirconium acetate hydroxide, zirconium neodecanoate, aluminum sulphate, aluminum stearate, iron sulphate and zinc sulphate and mixture thereof, preferably zirconium acetate.

In another aspect, the present invention is directed to an emulsified liquid composition comprising an acid-catalyst that is a Brönsted-Lowery acid, selected from at least one of acetic acid, acetylsalicylic acid, adipic acid, ascorbic acid, aspartic acid, benzenesulfonic acid, camphorsulfonic acid, citric acid, dihydroxy fumaric acid, esylic acid formic acid, glycolic acid, glutamic acid glyoxylic acid, hydrochloric acid, lactic acid, malic acid, malonic acid, maleic acid, mandelic acid, mesylic acid, oxalic acid, para-toluenesulfonic acid, pentanoic acid, phtalic acid, propionic acid, pyruvic acid, stearic acid, salicylic acid, sulfuric acid, tartaric acid, triflic acid, any amino acids, levulinic acid, succinic acid, hydrochloric acid (HCl), hydrobromic acid (HBr), hydroiodic acid (HI) or the halogen oxoacids: hypochloric acid, chloric acid, perchloric acid, periodic acid and corresponding compounds for bromine and iodine, or from any of sulfuric acid (H2SO4), sulphamic acid, fluorosulfuric acid, nitric acid (HNO3), phosphoric acid (H3PO4), fluoroantimonic acid, fluoroboric acid, hexafluorophosphoric acid, chromic acid (H2CrO4) or boric acid (H3BO3) and similar and mixtures thereof.

In another aspect, the present invention is directed to an emulsified liquid composition, comprising at least one of: a) a co-surfactant, preferably a non-ionic emulsifier having a HLB value from 1 to 41, suitably present in an amount of less than 7 wt%, more suitably 0.01 to 4 wt%, even more suitably 0.1 to 3 wt%, said co-surfactant, suitable is selected from at least one of alkyl polyethylene glycol ethers made from a C10-18 alcohol and ethylene oxide and polyoxyethylene lauryl ethers; b) a coalescent agent, such as at least one of butyldiglycol, monopropylene glycol, iso-propanol, ethanol and acetone, said coalescent agent is present in an amount of 0.01 to 20 wt%, preferably in an amount of 0.1 to 6 wt%, and most preferably in an amount of 0.5 to 3 wt%; c) a defoamer, such as EO/PO type defoamers, silicones, tri-butyl phosphate, alkylphthalates, emulsion type defoamers, fatty acid based defoamers, said defoamer is present in an amount of 0.05 to 10 wt%, preferably in an amount of 0.1 to 1 wt%; d) a rheology modifier, such as hydrophilic or hydrophobic silica nanoparticle or biopolymer such as carboxymethyl cellulose, suitably the rheology modifier is present in an amount of up to 5 wt%, preferably 0.1 to 2 wt%and more preferably 0.1 to 2 w%t; d) a preservative selected from one or more of fungicide, bactericide, pharmaceutical preservative, cosmetic preservative and food preservatives, said preservative is present in an amount of 0.005 to 10 wt%, preferably in an amount of 0.005 to 1.5 wt%, more preferably in an amount of 0.005 to 0.5 wt%; and e) a chain extender/crosslinker selected from one or more blocked prepolymer based on isocyanates or water based polycarbodiimide crosslinker present in an amount of 0.1 to 10 wt%, preferably in an amount of 0.2 to 8 wt%, more preferably in an amount of 0.5 to 5 wt%.

In a specific aspect, the present invention is directed to an emulsified liquid composition, comprising a) 0.2 to 30 wt% of the hydrophobic phase; b) 0.1 to 8 wt% of the emulsifying composition according to any of the previous defined aspects, wherein the selected Lewis acid is zirconium acetate present in amounts of 0.1 to 5 wt%; and c) optionally 0.1 to 3 wt%, of a co-surfactant, 0.5 to 3 wt% of a coalescent agent, 0.005 to 0.5 wt% of said preservative.

In other general aspect, the present invention is directed to a method of enhancing the hydrophobicity and water repellence of an inorganic, organic or fiber based materials and/ or enhancing the treated material’s ability to repel water soluble dirt, comprising: a) adding an emulsified liquid composition according, as defined in any previous aspect, to said inorganic, organic or fiber based material; b) optionally adjusting the amount of composition applied to said material; c) drying the treated inorganic, organic or fiber based materials until substantially or essentially dry; and d) optionally curing the treated inorganic, organic or fiber based materials at a temperature of between 10 to 200° C., more preferably for consumers 10 to 90° C., especially 15 to 60° C. and for industry 90 to 250° C., most preferably for industrial use is a temperature from 90 to 190° C.

In the described method, the emulsified liquid compositions of the invention can be applied to the fiber based material, by padding, spraying, washing, dipping/squeezing, brushing and similar techniques. Adjusting the amount of the emulsified liquid composition applied on materials can be performed either by controlling the uptake or by diluting the emulsion prior application.

By effect of the present invention as defined in the previous aspects, a fiber based material with a negatively loaded surface, for example from cellulose, the application of the emulsified compositions results in a natural attraction of the nitrogen in the amine and amide, which will point against the material. In this way the hydrophobic part of the organic amine and amide will point out from the treated material and the surface will attain a hydrophobic character.

### DESCRIPTION OF EMBODIMENTS OF THE INVENTION

### Positively Charged Emulsifying Composition

The “organic amide” of the positively charged emulsifying composition of the invention can be in the form of primary amide like MONO AMIDE (Saturated and Unsaturated fatty acid like Lauramide, Oleamide and similar where two hydrogen are linked to amine at X2 and X3), secondary amide like BIS AMIDE (Saturated and Unsaturated fatty acid like Hexamethylenebis oleamide and similar where just one hydrogen is linked to the amine at either X2 or X3) and tertiary amide like tris amide (Saturated and Unsaturated fatty acid like N-ethyl-N-methylhexanamide where no hydrogen is linked to amine at X2 and X3) where the molar ratio of carbon atoms to nitrogen atoms is 70≥C/N≥3, preferably 60≥C/N≥5 and most preferably 50≥C/N≥6. Different hydrophobic/hydrophilic ratios, surface activity, emulsifying capacity and hydrophobic effect can be achieved by using different type and ratios of the organic amides and organic amine of the invention. Also mixtures of two or several organic amides with different hydrophobicity/hydrophilicity can be used together with mixtures of organic amines to achieve the desired emulsifying properties and the required hydrophilic/lipophilic balance (HLB) depending on the hydrophobic character of the discrete phase.

The organic amine of the positively charged emulsifying composition of the invention can be a combination of one or more of organic amines in the form of fatty amines (primary, secondary and tertiary amines where Y4 and Y5 can be either hydrogen and hydrocarbons such as Oleylamine and/or Tallow amine and/or (12E,15E)-N-[(21E,24E)-hexatriaconta-21,24-dienyl]hexatriaconta-12,15-dien-1-amine sold as Priamine 1071, 1073, 1074 and 1075 by Croda and/or Dodecyldimethylamine and similar), amino acids (such as L-Leucine and similar) and amine containing polymers (primary, secondary and tertiary amines in the polymeric form such as Chitosan, polyaspartic esters and similar) where the molar ratio of carbon atoms to nitrogen atoms is 70≥C/N≥3, preferably 60≥C/N≥5 and most preferably 50≥C/N≥6.

### Hydrophobic Phase/Discrete Phase of the Emulsified Liquid Compositions of the Invention

Useful hydrophobic chemicals can be selected from alkylalkoxysilane, organofunctional silanes, organofunctional siloxanes, synthetic or natural organic/mineral waxes, synthetic or natural organic/mineral oils and similar non water soluble hydrophobizing agents.

The hydrophobic agent may be synthetic or natural organic/mineral waxes, vegetable or animal waxes. They waxes may preferably be selected from the group consisting of Bayberry wax, candelilla wax, carnauba wax, castor wax, esparto wax, japan wax, ouricury wax, rice bran wax, soy wax, tallow tree wax, beeswax, Chinese wax, lanolin wax (wool wax), shellac wax, spermaceti wax, ozocerite, oryza sativa (rice) bran wax, carbowax, Fischer-Tropsch waxes, jojoba wax, joyoba esters, vegetable wax (copernica cerifera), cetyl esters, thembroma cacao (cocoa) seed butter, palm wax and mixtures thereof.

The waxes may as well be mineral, synthetic waxes and/or petroleum derived waxes, and may preferably be selected from the group consisting of paraffin wax, microcrystalline wax, ceresin wax, montan wax, ozocerite wax, polyethylene wax, peat wax, and mixtures thereof.

The hydrophobic agent according to the present invention can be selected from the group consisting of synthetic or natural organic/mineral oils. The natural oil may be a vegetable oil, preferably selected from the group consisting of sunflower oil, soy bean oil, corn oil, cottonseed oil, palm oil, oleine palm oil, palm kernel oil, tall oil, pine oil, peanut oil, rapeseed oil, safflower oil, sesame oil, rice bran oil, coconut oil, canola oil, avocado oil, olive oil, linseed oil, grape seed, groundnut oil, rice bran oil, perilla 30 oil, tsubaki oil, hemp seed oil, tung oil, kapok oil, tea seed oil, almond oil, aloe vera oil, apricot kernel oil, baobab oil, calendula oil, corn oil, evening primrose oil, grape oil, grape seed oil, hazelnut oil, jojoba oil, macadamia oil, natural oils, neem oil, non-hydrogenated oils, partially hydrogenated oils, sesame oil, or similar, epoxidized vegetable oils such as epoxidized soya bean oil, epoxidized fatty acid methyl esters, preferably selected from sunflower oil, soy bean oil, tall oil, corn oil, rapeseed oil, coconut oil and palm oil, and more preferably from sunflower oil, and mixtures thereof. The natural oil may as well be an essential oil, preferably selected from the group consisting of oils extracted from Aniseed, Basil, Benzoin, Bergamot, Black Pepper, Camphor, Carrot, Cedarwood, Chamomile German, Chamomile Maroc, Chamomile Roman, Cinnamon Leaf, Clove Buds, Cypress, Dill, Eucalyptus Globulus, Fatigue, Fennel, Frankincense, Ginger, Grand Fir, Grapefruit, Grapeseed, Hazel, Hyssop, Jojoba, Juniper, Juniper Berry, Lavender, Lemon, Lemon Grass, Melissa, Mountain Savoury, Myrtle Red, Neroli, Niaouli, Patchouli, Peppermint, Pine, Red Myrtle, Rescue Remedy, Rose Geranium, Rosemary, Sandlewood, Spanish Marjoram, Sweet Marjoram, Sweet Thyme, Tagetes, Tea Tree, Thyme Red, Thyme Sweet, Ylang Ylang, and mixtures thereof. The natural oil may be an animal oil, preferably selected from the group consisting of animal fat or oil, sperm oil, lard, tallow, fish or whale oil, fish liver oil, milk fat, wool oil, wool grease, lanolin, bone oil, lard oil, goose grease, preferably selected from fish oil and bone oil, and mixtures thereof. The natural oil may as well be a polymerized natural oil, preferably selected from any polymerized oil as described above, such as polymerized soy bean oil, and mixtures thereof. The fatty compound may be a synthetic oil, preferably selected from the group consisting of pure or blends of light mixtures of high alkanes from a mineral source such as mineral oil, white oil, liquid paraffin, and liquid petroleum, full synthetic oil, poly-alpha-olefin (PAO) oil, Group V base oil, Group I-, II-, II+-, and III-type of mineral-base oil (as defined by API), semi-synthetic oil such as mixture of mineral oil and synthetic oil, preferably selected from liquid paraffin and mineral oil, most preferably from liquid paraffin, and mixtures thereof.

The hydrophobic agent may be a linear or branched C4-C40 fatty alcohol, preferably selected from the group consisting of tert-butyl alcohol, tert-amyl alcohol, 3-methyl-3 pentanol, ethchlorvynol, 1-octanol (capryl alcohol), pelargonic alcohol (1-nonanol), 1-decanol (decyl alcohol, capric alcohol), undecyl alcohol (1-undecanol, undecanol, hendecanol), lauryl alcohol (dodecanol, 1-dodecanol), tridecyl alcohol (1-tridecanol, tridecanol, isotridecanol), myristyl alcohol (1-tetradecanol), pentadecyl alcohol (1-pentadecanol, pentadecanol), cetyl alcohol (1-hexadecanol), palmitole yl alcohol (cis-9-hexadecen-1-ol, heptadecanol), stearyl alcohol (1-octadecanol), nonadecyl alcohol (1-nonadecanol), arachidyl alcohol (1-eicosanol), heneicosyl alcohol (1-heneicosanol), behenyl alcohol (1-docosanol), erucyl alcohol (cis-13docosen-1-ol), lignoceryl alcohol (1-tetracosanol), ceryl alcohol (1-hexacosanol), 1-heptacosanol, montanyl alcohol (cluytyl alcohol, 1-octacosanol), 1-nonacosanol, myr icyl alcohol (melissyl alcohol, 1-triacontanol), 1-dotriacontanol (lacceryl alcohol), geddyl alcohol (1-tetratriacontanol), cetearyl alcohol. The fatty alcohol may preferably be selected from lauryl alcohol, stearyl alcohol, oleyl alcohol, palmitoleyl alcohol, erucyl alcohol, cetyl alcohol, myrist yl alcohol, ceryl alcohol and behenyl alcohol, more preferably from stearyl alcohol, oleyl alcohol, palmitoleyl alcohol, cetyl alcohol, ceryl alcohol and behenyl alcohol (due to low toxicity), and mixtures thereof.

The hydrophobic agent may also be a fatty silane, having at least one hydrophobic moiety and one to three hydrolysable alkoxy, hydroxy and/or halide groups respectively, wherein the hydrophobic moiety is selected from n-, iso, cyclic or mixtures thereof of C1-C30 saturated or unsaturated carbon chains, and wherein the alkoxy group is an alkoxy group comprising 1-4 carbon atoms, preferably selected from the group consisting of acetoxy, methoxy, ethoxy, propoxy, or butoxy. The fatty silane may be selected from the group consisting of methyltrialkoxy silane, potassium methyl siliconate, propyltriethoxy silan, butyl triethoxy silane, hexyltriethoxy silane, octyltriethoxy silane, dodecyltrimethoxy silane, hexadecyltrimethoxy silane, hexadecyltriethoxy silane, octadecyltrimethoxy silane, octadecyltriethoxy silane, preferably selected from octyltriethoxy silane and hexadecyltrimethoxy silane, and mixtures thereof.

The hydrophobic agent may be a fatty siloxane having a polydimethylsiloxane backbone, functionalized with one or more organofunctional groups selected from the group consisting, of hydroxy, epoxy, amine, amide, aldehyde, carboxy, thiol, ether, ester, oxime, imine, cyanate, blocked isocyanate, urethane, alkyl, alkene, alkyn, aryl, acetoxy, methoxy, ethoxy, propoxy(for example n-propoxy, isopropoxy) or butoxy groups. The fatty siloxane may also be selected from the group consisting of reactive or non-reactive aminosiloxane, polydimethylsiloxane, alkylamino siloxane, ethylphenyl-polydimethylsiloxane, hydroxyterminated polydimethylsiloxane, hexadecyl N-ethylaminpropyl polydimethylsiloxane, octyl N-ethylaminpropyl polydimethylsiloxane, hexadecyl aminpropyl, polydimethylsiloxane, hexadecylpolydimethylsiloxane, hexadecylpolydimethylsiloxane, and mixtures thereof, more preferably from hexadecyl modified aminosiloxane.

Additionally, the hydrophobic agent may be a fatty epoxide, fatty imine, fatty aldehyde, fatty imide, fatty thiol, fatty sulfate, fatty ester, or fatty ketone, having a linear and/or branched chain comprising 4 to 40 carbon atoms, said chain being saturated or unsaturated with one or more double and/or triple bonds, and mixtures thereof.

Furthermore, the hydrophobic agent may be other type of lipid, such as phospholipid, glyceride, triglyceride, glycolipid, wherein said phospholipid is preferably lecithin, wherein said triglyceride contains at least one of the fatty acids of claim 4, and mixtures thereof.

It is obvious to the person skilled in the art, that the one or more hydrophobic agents according to the present invention may be independently of each other selected from one or more of the above listed categories and under-categories of compounds.

### Acid-Catalyst of the Emulsified Liquid Compositions of the Invention

The acid-catalyst in the present invention has three functionalities. It can be used for protonation of or coordination to the organic amine and amide functional groups in the emulsifying agents I and II and induce their surface activities by creating a partial or full cationic charge. Also in some cases it can work as adhesion booster by catalyzing the reaction of the oil phase with the treated material through the provided surface charges and formed complexes. It can also initiate the hydrolysis and condensation reaction when for example silanes are used in the hydrophobic phase.

When a Lewis Acid catalyst is used as the acid-catalyst in the emulsified composition of the invention, it can be is selected from polyvalent metal salts of 2, 4, 8, 12 and 13 in the periodic table of elements such as Ti, Zr, Hf, Fe, Zn, Al and similar. Examples of polyvalent Lewis acid metal salts that are useful in the emulsifying composition according to the invention are zirconium acetate solution, zirconium acetate powder, zirconium propionate, zirconium nitrate, zirconium acetate hydroxide, zirconium neodecanoate, aluminum sulphate, aluminum stearate, zinc sulphate, iron sulfate and similar and mixtures thereof. The preferred catalysts are chosen from zirconium based catalysts.

When a Bronsted-Lowery acid is used as the acid catalyst in the emulsified composition of the invention, it should be readily soluble or dispersible in water, and have a pKa < 7. Additionally the chosen acid should not interfere with the water repellency effect of the material after treatment. The Bronsted-Lowery acid can be selected form organic and inorganic acids. The organic acid is selected from one or more of acetic acid, acetylsalicylic acid, adipic acid, ascorbic acid, aspartic acid, benzenesulfonic acid, camphorsulfonic acid, citric acid, dihydroxy fumaric acid, esylic acid formic acid, glycolic acid, glutamic acid glyoxylic acid, hydrochloric acid, lactic acid, malic acid, malonic acid, maleic acid, mandelic acid, mesylic acid, oxalic acid, para-toluenesulfonic acid, pentanoic acid, phtalic acid, propionic acid, pyruvic acid, stearic acid, salicylic acid, sulfuric acid, tartaric acid, triflic acid, any amino acids, levulinic acid and succinic acid and mixtures thereof. The inorganic acid is selected from any of hydrogen halides: hydrochloric acid (HCl), hydrobromic acid (HBr), hydroiodic acid (Hl) or the halogen oxoacids: hypochloric acid, chloric acid, perchloric acid, periodic acid and corresponding compounds for bromine and iodine, or from any of sulfuric acid (H2SO4), sulphamic acid, fluorosulfuric acid, nitric acid (HNO3), phosphoric acid (H3PO4), fluoroantimonic acid, fluoroboric acid, hexafluorophosphoric acid, chromic acid (H2CrO4) or boric acid (H3BO3) and mixtures thereof.

### Water

Water is present in the emulsified liquid composition as a solvent, for example in amounts of 38-99.98 weight wt%.

### Optional Co-Surfactant

The wording co- surfactant may according to the present invention also refer to any surfactant or stabilizer. A co- surfactant may be ionic or non-ionic. The co-surfactant may be chosen from the class of surfactants known as non-ionic emulsifiers having HLB values between 1-41 that have the ability to aid the emulsification of the hydrophobic agents in water. In one embodiment the emulsifier is not affecting the reactivity of the catalyst and the hydrophobizing agent. In a preferred embodiment of the invention, co-emulsifiers are used in amounts of less than 7 wt% or between 0.01-4 wt%, most preferably 0.1-3 wt%. Examples of suitable co-surfactants include, but are not limited to, Lutensol TO5 from BASF, Lutensol TO7 from BASF, Brij S2 from CRODA, Brij S10 from CRODA and similar.

### Optional Coalescent Agent

The coalescent agents are present in order to enhance the stability and the film forming properties of said applied emulsion. Examples of suitable coalescent agents include, but are not limited to, butyldiglycol, monopropylene glycol, iso-propanol, ethanol and acetone.

### Optional Rheology Modifier

Rheology modifiers can be used in order to change the rheology profile to fit a specific type of application method.

### Optional Defoamer

A defoamer is used to reduce or remove foaming during production and application

### Optional Preservative

A preservative is used for storage stability and protection against microbial attack.

### Optional Chain Extender/Crosslinker

Chain extender/cross-linker can be used in order to introduce new chemical bonds and boost chemical bonding/durability between the hydrophobizing agents and other functional chemicals of the invention or to the applying surfaces. Non limiting examples of chain extenders/crosslinkers are blocked prepolymer based on isocyanates such as Ruco-Link Bew 4945 manufactured by Rudolf Chemie or Phobol XAN manufactured by Huntsman or water based polycarbodiimide crosslinker such as PICASSIAN® XL-732 and PICASSIAN® XL-702 manufactured by Stahl Europe BV.

### Apparatus

The emulsified composition of the invention can be produced with any kind of laboratory or industrial equipment using low and/or high shear forces for producing the emulsified composition of the invention. Examples of suitable apparatus are magnet stirrer, overhead stirrer with propeller or disperser or like, homogenizer with or without high pressure, in-line or external homogenizers, extruders, shaking equipment, mortar and pestle, blender type of instrument, any kind of mixer (static mixer, micro mixer, vortex mixer, industrial mixer, ribbon blender, V blender, continuous processor, cone screw blender, screw blender, double cone blender, double planetary, high viscosity mixer, counter-rotation, double and triple shaft, vacuum mixer, high shear rotor stator, dispersion mixer, paddle, jet mixer, mobile mixer, drum mixer, intermix mixer, planetary mixer, Banbury mixer or like), French press, disintegrator, mill (grinding by bead mill, colloid mill, hammer mill, ball mill, rod mill, autogenous mill, semiautogenous grindning, pebble mill, high pressure grinding rolls, buhrstone mill, vertical shaft impactor mill, tower mill or like), ultrasonic treatment, rotor-stator mechanical equipment, any kind of propeller or mixer, high temperature and/or high pressure bitumen emulsifiers or combinations thereof.

### DETAILED AND EXEMPLIFYING PART OF THE INVENTION

### Evaluation Methods

For determination of resistance to surface wetting (spray test) of fabrics, European Standard EN 24 920 (ISO 4920:1981) was used. The principles of this standard are the following: A specified amount of water is sprayed on a textile specimen mounted on a ring. The specimen is disposed at an angle of 45° in respect to the nozzle. The center of the standardized nozzle is disposed at a given distance above the center of the specimen. A given amount of water is filled in a reservoir disposed above the nozzle and in communication with it. The spray rating is determined visually and/or photographically. The stepwise spray rating scale of ISO 1-5 corresponds to 50-100% of the specimen having withstood wetting. The scale correlation is 100 % (ISO 5), 97-5 % (ISO -5), 92.5 % (ISO +4), 90 % (ISO 4), 87.5 % (ISO -4), 82.5 % (ISO +3), 80 % (ISO 3), 77-5 % (ISO -3), 72.5 % (ISO +2), 70 % (ISO 2), 66.67 % (ISO -2), 56.67 % (ISO +1), 50 % (ISO 1) of the specimen having withstood wetting.

Dynamic contact angle measurements were performed using PGX Serial 50585 contact angle measuring device on the surfaces of the treated and non-treated paper boards for 120 seconds.

Curing of fabrics were made in a preheated Wichelhaus WI-LD3642 Minidryer/Stenter frame oven or Termaks TS 8136 oven at the given temperatures and times, or room temperature (5-30° C.) hang drying, or tumble drying at the given time and temperatures or ironing at the given heat. The water-repellency properties of the treated textile before and after machine washing, using an aqueous solution of a IEC reference detergent B, were evaluated (washing temperature 40° C./duration approximately 90 minutes) by testing the textile with the standardized tests SS- EN 24 920.

Stability of the compositions was determined by following changes in viscosity using a Brookfield DV-11 Pro viscometer and visually by evaluation of phenomenas such as creaming or phase separation. 250 g of each emulsion were kept in 250 ml flasks with sealed cap at three different temperatures; room temperature (23° C.), 40° C. (Incucell, L LSIS-B2V/IC 55) and 50° C. (Avantgarde ED 115).

### General Procedures for the Preparation of the Emulsion of the Invention

The invented emulsifying system can be utilized in different emulsification processes using different amounts of the emulsifiers, hydrophobic chemicals, Lewis acid/catalysis and water. The process temperature in the premixing stage of the components or the homogenization of the dispersing phase in water as continuous phase should preferably be, but not limited to, higher than the melting point of the solid components in the mixture.

In order to prepare the emulsion with finest particle size, for better stability and functionality a good homogenization is a requirement. A higher shear force from the homogenizer device will provide smaller emulsion droplet sizes which normally leads to more stable emulsions. By balancing the dispersed phase and the continuous phase the use of conventional stirrers can be enabled, in the preparation of the final emulsion. However, the use of high shear homogenizer is preferred. Non limiting examples of high shear homogenization can be accomplished using high shear propeller, homogenizer, in line-homogenizer, sonication and high pressure homogenizer.

The following preparation method examples should not be interpreted as limiting the scope of the invention set forth in the claims. All percentages in these examples are weight percentages (wt%), unless otherwise indicated:

### Preparation Method 1

In a beaker organic amide, organic diamine, hydrophobic agent, coalescing agents and warmed deionized water were charged (the temperature of the water preferably can be adjusted generally just higher than melting point (mp) of the component with highest mp). The mixture was pre-homogenized primarily for short time. Then a solution of Acid/Catalyst was added to the mixture and homogenizing continued until optimal particle size was achieved.

### Preparation Method 2

In a beaker a hydrophobic agent, organic amide, organic amine, optionally coalescing agents and co-surfactant were charged. The mixture was stirred using magnetic stirrer at moderate speed using warm water bath until the dispersed phase was prepared called phase I (the temperature of the water preferably can be adjusted generally just higher than melting point (mp) of the component with highest mp). The Acid/Catalyst was added to warm deionized water called phase II. Phase II was homogenized for short time. Phase I was added gradually to phase II while homogenizing. The homogenization was thereafter continued until optimal particle size was achieved.

### Preparation Method 3

In a beaker hydrophobic agent, organic amide, optional coalescing agents and co-surfactant were charged. The mixture was stirred using magnetic stirrer at moderate speed using warm water bath until homogenized phase was prepared called phase I (temperature of the water preferably can be adjusted generally just higher than melting point (mp) of the component with highest mp). The Acid/Catalyst and water soluble organic amine were added to warm deionized water called phase II. Phase II was mixed until consistent aqueous phase was prepared. Phase II was then homogenized for short time. Phase I was added gradually to phase II while homogenizing. The homogenization was thereafter continued until optimal particle size was achieved.

Used chemicals and materials

Table 1

Chemicals used in the following examples

| | | | |
|---|---|---|---|
| Chemical | Trade name | Description | Supplier/distributor |
| Oleyl palmitamide | Crodamide 203 | Fatty amide (C/N molar ratio of =34) | CRODA |
| Dimer Diamine | Priamine 1073 | Organic amine (C/N molar ratio of =18) | CRODA |
| Hydrophobic Natural Wax (Carnauba wax) | Syncrowax™ HGLC | Mp=60-70° C. | CRODA |
| Mono propylene glycol | Radianol 4713 | Coalescing agents | Oleon |
| Zirconium acetate Powder | | Acid/Catalyst | AMPI SRL |
| Steareth-10 | Brij S10 | Surfactant | CRODA |
| Stearyl erucamide | Crodamide 212 | Fatty amide (C/N molar ratio of =40) | CRODA |
| Sorbitan stearate | Span 60 | Co-surfactant | CRODA |
| Hydrophobic Natural Wax | NATUREBEAD® G20NATUREBEAD® G20 | Mp= 45-53° C. | Micro Powders, Inc. |
| Hexadecyltrimethoxy silane | WACKER® SILANE 25013 VP | Hydrophobic monomer | Wacker Chemie AG |
| Octyl triethoxy silane | Silres BS 1601 | Hydrophobic monomer | Wacker Chemie AG |
| Butyl diglycol | | Coalescing agents | Univar Solutions |
| Oleic acid | RADIACID 0212 | Hydrophobic monomer/Acid | Oleon |
| L-Phenylalanine | | Amino acid/ Organic amine | Kyowa Hakko Europe GmbH |
| Oleamide | Crodamide VRX | Fatty amide (C/N molar ratio of =18) | CRODA |
| Chitosan | | Organic amine (C/N molar ratio of =6) | Zhejiang Aoxing Biotechnology CO.,LTD. |
| Acetic acid | | Acid 60 wt% | Univar Solutions |
| Oxime-blocked isocyanate | PHOBOLXAN | Chain extender | Huntsman |

Table 2

Materials used in the examples

| | |
|---|---|
| Material | Description |
| Polyester textile | White color, 128 g/m2 |
| Polyamide textile | Dark blue color, 58 g/m2 |
| Scot Pine sapwood | Scot Pine sapwood, 530 kg/m3 |
| Scot Pine wood | Scot Pine mix of sap and heartwood, 510 kg/m3 |
| Aluminium foil | 36 g/m2 |
| LDPE film | Low density polyethylene, 48 g/m2 |
| Glass slides | 2,43 kg/m2 |
| Cellulose paper | 90 g/m2 |

### Examples of the Invention

The examples of Table 3 below are intended to illustrate the invention to those skilled in the art and should not be interpreted as limiting the scope of the invention set forth in the claims. All percentages in these examples are weight percentages, unless otherwise indicated:

Table 3

Composition recipes used in the examples
Compositions

| | |
|---|---|
| Composition 1^{1,2} | 0.5 wt% Crodamide 203 (Oleyl palmitamide: Fatty amide), 0.15 wt%Priamine 1073 (Dimer Diamine: Organic amine), 2 wt% Carnauba wax mp=60-70° C. (Hydrophobic Natural Wax), 1 wt% Mono propylene glycol (Coalescing agents), 2 wt% Zirconium acetate solution (Acid/Catalyst), 94.35 wt% water |
| Comparative composition 2^{1,2} | 1 wt% Brij S10 (Surfactant), 2 wt% Carnauba wax mp=60-70° C. (Hydrophobic Natural Wax), 1 wt% Mono propylene glycol (Coalescing agents), 2 wt% Zirconium acetate solution (Acid/Catalyst), 94 wt% water |
| Composition 3^{1,2} | 0.5 wt% Crodamide 212 (Stearyl erucamide: Fatty amide), 0.15 wt% Priamine 1073 (Dimer Diamine: Organic amine), 1 wt% Span 60 (Co-surfactant), 3 wt% NATUREBEAD® G20 (Hydrophobic Natural Wax), 1 wt% Mono propylene glycol (Coalescing agents), 0.4 Brij S10 (Co-surfactant), 2 wt% Zirconium acetate solution (Acid/Catalyst), 91.95 wt% water |
| Composition 4² | 3 wt% Wacker Silane 25013 (Hydrophobic monomer), 4 wt% Silres BS 1601 (Hydrophobic monomer), 1 wt% Crodamide 203 (Oleyl palmitamide: Fatty amide), 0.3 wt% Priamine 1073 (Dimer Diamine:Fatty amine), 1 wt% NATUREBEAD® G20(Hydrophobic Natural Wax), 0.6 wt% Butyl diglycol (Coalescing agents), 0.5 wt% Oleic acid (Hydrophobic monomer, Acid), 0.4 wt% Brij S10 (Co-surfactant), 0.5 wt% Span 60 (Co-surfactant), 3 wt% Zirconium acetate solution (Acid/Catalyst), 85.7 wt% water |
| Composition 5^{1,2} | 0.5 wt% Crodamide 212 (Stearyl erucamide: Fatty amide), 0.15 wt% Phenylalanine (Amino acid: Organic amine), 1 wt% Span 60 (Co-surfactant), 3 wt% NATUREBEAD® G20 (Hydrophobic Natural Wax), 1 wt% Mono propylene glycol (Coalescing agents), 0.4 Brij S10 (Co-surfactant), 2 wt% Zirconium acetate solution (Acid/Catalyst), 91.95 wt% water |
| Composition 6³ | 1 wt% Crodamide VRX (Oleamide: Fatty amide), 0.2 wt% Chitosane (aminated biopolymer: Organic amine), 2 wt% Span 60 (Co-surfactant), 2 wt% NATUREBEAD® G20 (Hydrophobic Natural Wax), 0.5 Oleic acid (Hydrophobic monomer, Acid), 0.6 wt% Mono propylene glycol (Coalescing agents), 0.4 Brij S10 (Co-surfactant), 3 wt% Zirconium acetate solution (Acid/Catalyst), 86.3 wt% water |
| Composition 7^{1,2} | 0.5 wt% Crodamide VRX (Oleamide: Fatty amide), 0.15 wt% Priamine 1073 (Dimer Diamine:Fatty amine), 1 wt% Span 60 (Co-surfactant), 3 wt% NATUREBEAD® G20 (Hydrophobic Natural Wax), 0.5 wt% Oleic acid (Hydrophobic monomer, Acid), 1 wt% Mono propylene glycol (Coalescing agents), 0.4 Brij S10 (Co-surfactant), 4 wt% Acetic acid (60 wt%) (Acid), 89.45 wt% water |
| Composition 8^{1,2} | 0.5 wt%Crodamide VRX (Oleamide: Fatty amide), 0.15 wt% Priamine 1073 (Dimer Diamine:Fatty amine), 1 wt% Span 60 (Co-surfactant), 3 wt% NATUREBEAD® G20 (Hydrophobic Natural Wax), 0.5 wt% Oleic acid (Hydrophobic monomer, Acid), 1 wt% Mono propylene glycol (Coalescing agents), 0.4 Brij S10 (Co-surfactant), 4 wt% Acetic acid (60 wt%) (Acid), 2 wt%Zirconium acetate solution (Acid/Catalyst), 87.45 wt% water |

prepared according to preparation method 1, ² prepared according to method 2 and ³prepared according to method 3

### Example 1. Comparison to Traditional Surfactant

In this example a polyester textile was treated using composition 1 or comparative composition 2, see table 4.

Table 4

Performance comparison of composition 1 and comparative composition 2
Spray test scores

| Label | Fabric | Dilution* | Formulation stability at room temperature | Application method | Curing T(°C)/ curing time (min) | Initial spray score |
|---|---|---|---|---|---|---|
| Composition 1 | White 100 wt% polyester textile | 1:2 | Stable ≥6 months | Dipping/ squeezing | <55/15 tumble drier | 5- |
| Comparative composition 2 | White 100 wt% polyester textile | 1:2 | Precipitation after 1 day | Dipping/ squeezing | <55/15 tumble drier | 3 |

*Dilution was made using 1 part composition to 2 parts water

After curing the treated textiles they were subjected to evaluation using EN 24 920. It can be concluded that composition 1 outperforms comparative composition 2 when it comes to spray score. Also a comparison was made on the emulsion stability of the compositions. It can be clearly seen that composition 1 is stable over longer period of time than comparative composition 2.

### Example 2. Different Amine and Amides

In the below example four compositions according to the invention using different amines and amides were prepared. All of them perform well in terms of spray scores on different textiles using different application techniques and different curing conditions.

Table 5

Performance of two compositions with different amines on textile
Spray test scores

| Label | Fabric | Dilution* | Application method | Curing T(°C)/ curing time (min) | Initial spray score | 1 wash |
|---|---|---|---|---|---|---|
| Composition 3 | White 100 wt% polyamide textile | 1:2 | Spraying | <55/15 tumble drier | 5- | 5- |
| Composition 5 | White 100 wt% polyester textile | 1:2 | Spraying | <55/15 tumble drier | 4+ | 4++ |
| Composition 4 | White 100 wt% polyester textile | 1:2 | Padding | 170/2 | 5- | 5- |
| Composition 6 | White 100 wt% polyester textile | 1:2 | Padding | 170/2 | 4+ | 5- |

*Dilution was made using 1 part composition to 2 parts water

### Example 3. Different Curing Temperatures

In this example, it is shown that good performance in terms of spray scores on textiles can be achieved using low to high temperatures.

Table 6

Performance of composition 4 using different curing temperatures
Spray test scores

| Label | Fabric | Dilution* | Application method | Curing T(°C)/ curing time (min) | Initial spray score | 1 wash |
|---|---|---|---|---|---|---|
| Composition 4 | White 100 wt% polyester textile | 1:2 | Spraying | Room temperature (25±1) hang drying /1 day | 4+ | 5- |
| | White 100 wt% polyester textile | 1:2 | Spraying | <55/15 tumble drier | 5- | 5- |
| | White 100 wt% polyester textile | 1:2 | Spraying | 170/2 | 5- | 5- |

*Dilution was made using 1 part composition to 2 parts water

### Example 4. Application Methods

In this example, it is shown that good performance in terms of spray scores on textiles can be achieved using different application techniques.

Table 7

Performance of composition 4 using different application methods
Spray test scores

| Label | Fabric | Dilution* | Application method | Curing T(°C)/ curing time (min) | Initial spray score | 1 wash |
|---|---|---|---|---|---|---|
| Composition 4 | White 100 wt% polyester textile | 1:2 | Dipping/ squeezing | <55/15 tumble drier | 5- | 5- |
| | White 100 wt% polyester textile | 1:2 | Spraying | <55/15 tumble drier | 5- | 5- |
| | White 100 wt% polyester textile | 1:2 | Padding | <55/15 tumble drier | 5- | 5- |

*Dilution was made using 1 part composition to 2 parts water

### Example 5. Compatibility with Commercially Available Chain Extender and Durability

In order to test the compatibility of a composition of the invention with commonly used chemicals within for example the textile industry, composition 3 was diluted and mixed with PHOBOL XAN chain extender. The results are presented in table 8. It can clearly be seen that the compatibility between composition 3 and PHOBOL XAN is good and results are as expected. After 5 and 10 washes the treated textile maintains higher spray score with the addition of PHOBOL XAN acting in concurrence with composition 3 than without.

Table 8

Compatibility with commercial additive
Spray test scores

| Label | Fabric | Dilution*/ additive | Application method | Curing T(°C)/ curing time (min) | Initial spray score | 1 wash | 5 washes | 10 washes |
|---|---|---|---|---|---|---|---|---|
| Composition 3 | Dark blue 100 wt% polyamide textile | 1:5/- | Padding | 170/2 | 5- | 4+ | 3+ | 3 |
| | Dark blue 100 wt% polyamide textile | 1:5/1.5 wt% PHOBOL XAN | Padding | 170/2 | 5- | 5- | 4+ | 4+ |

*Dilution was made using 1 part composition to 5 parts water

### Example 6. Stability

In order to evaluate the stability of the O/W emulsions prepared according to the invention, these were subjected to different conditions. In one test concerning dilution stability the samples are diluted and subjected to different aging temperatures and thereafter evaluated in terms of viscosity and visual changes. In the second test non-diluted emulsions are subjected to different temperatures and subsequently evaluated visually and by measuring viscosity, see table 9.

Table 9

Oil in water (O/W) emulsion stability

| Label | Dilution | pH | Stored at Temp (°C) | Viscosity mPas | |
|---|---|---|---|---|---|
| | | | | Original | Aged |
| Composition 4 | Not diluted | 3.8 | 23 | ^{~}1.5 | No visual change in 2 years |
| | | | 40 | ^{∼}1.5 | No visual change in 8 months |
| | | | 50 | ^{∼}1.5 | No visual change in 3 months |
| Composition 4 | 1 part Composition 4 to 3 parts of water | 3.8 | 23 | ^{∼}1.5 | No visual change in 2 years |
| | | | 40 | ^{∼}1.5 | No visual change in 8 months |
| | | | 50 | ^{∼}1.5 | No visual change in 3 months |
| Composition 5 | Not diluted | 3.9 | 23 | ^{∼}1.5 | No visual change in 1 years |
| | | | 40 | ^{∼}1.5 | No visual change in 2 months |
| | | | 50 | ^{∼}1.5 | No visual change in 1 months |
| Composition 7 | 1 part Composition to 1 parts of water | 3.9 | 23 | ^{~}1.5 | No visual change in 1 years |
| | | | 40 | ^{∼}1.5 | No visual change in 2 months |
| | | | 50 | ^{∼}1.5 | No visual change in 1 months |
| | | | 40 | ^{∼}1.5 | No visual change in 8 months |
| | | | 50 | ^{∼}1.5 | No visual change in 3 months |

From table 9 it can be concluded that the above prepared compositions according to the invention are considered to be dilution stable and stable over time, minimum according to the depicted times.

### Example 7. Performance on Different Materials

Composition 1 of the invention was tested on several different materials in order to evaluate the performance on different materials and surfaces by measuring the contact angle of water on the treated surface.

Table 10

Comparison of treated and non-treated materials and surfaces

| Material | Surface treatment | Curing T(°C)/ curing time (min) | Contact angle |
|---|---|---|---|
| Pine sapwood | Not treated | | 76.7° |
| | Composition 1 | Room temperature (23±1)/ 1 day | 95.8° |
| Aluminium foil | Not treated | | 61.1° |
| | Composition 1 | Room temperature (23±1)/ 1 day | 84.3° |
| LDPE film | Not treated | | 84.4° |
| | Composition 1 | Room temperature (23±1)/ 1 day | 90.2° |
| Cellulose paper (70 mm) | Not treated | | 0° |
| | Composition 1 | Room temperature (23±1)/ 1 day | 90.1° |
| Glass | Not treated | | 13.8° |
| | Composition 1 | Room temperature (23±1)/ 1 day | 81° |
| White 100 wt% polyester textile | Not treated | | 0° |
| | Composition 1 | Room temperature (23±1)/ 1 day | 97.1° |

In all cases, according to table 10, the contact angle is increased after treatment with composition 1, which means that better hydrophobic properties are achieved. These results also demonstrate the broad application area of the composition for different materials and surfaces.

### Example 8. Physical Change on Materials

Composition 4 of the invention was tested on White 100 wt% Polyester in order to evaluate hands-feeling and color change on different materials and surfaces.

Table 11

Evaluation of the stiffness/softness and yellowing/color change of treated textiles

| | Fabric | Sensory panel evaluation of softness | Sensory panel evaluation of yellowing |
|---|---|---|---|
| Comp. composition 2 | White 100 wt% Polyester | 3 | 0 |
| Composition 4 | White 100 wt% Polyester | 0 | 0 |

The treated polyester textiles according to table 11 were submitted for sensory panel evaluation. The sensory panel utilized individuals trained to compare textile products and evaluate softness/stiffness and yellowing/color changes (against original untreated textile). Stiffness was ranked on a scale from 0 describing a very soft hand feel, to 7 describing a stiff hand feel. Color changes/yellowing was ranked on a scale from 0, describing no change, to 7 describing as big visual change. According to the results shown in table 12 it can clearly be seen that the emulsions according to the invention could offer very soft feeling along with very low yellowing on the treated textiles.

1. An emulsifying composition comprising:
a) at least one positively charged organic amide selected from at least one of a polymeric amide and an amide according to the general formula I: 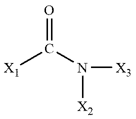
wherein X1, X2 and X3 are same or different groups, so that the molar ratio of carbon atoms to nitrogen atoms of said at least one amide is 70>C/N≥3, wherein the amide according to the general Formula I is selected from primary, secondary and tertiary amides of saturated or unsaturated, branched or linear acid(s) with total carbon of less than 150 of carbon atoms, and wherein the amide according to the general Formula I is selected from primary, secondary or tertiary amides of saturated or unsaturated, branched or linear acids which are not water soluble at a pH of 1 to 7; and
b) at least one positively charged organic amine selected from at least one of a polymeric amine and an amine according to the general formula II below: 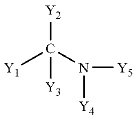
wherein Y1, Y2, Y3, Y4 and Y5 are same or different groups, so that the molar ratio of carbon atoms to nitrogen atoms of said at least one amine is 70≥C/N≧3, preferably 60≧C/N≧5, and more preferably 50≥C/N≥ 6, and wherein the amine according to the general Formula II is selected from primary, secondary or tertiary amine with total carbon of less than 150 carbon atoms, wherein the amine according to the general Formula II is not water soluble at a pH of 1 to 7, and wherein the amine is selected from primary, secondary or tertiary amines with saturated or unsaturated, branched or linear hydrocarbons chains or wherein the amine is an amine derived from saturated or unsaturated, branched or linear acids; and
a) at least one Lewis acid and/or at least one Brönsted acid selected from Lewis acid from groups 2, 4, 8, 12 and 13 in the periodic table of elements and Brönsted acids with a pka of < 7.

2. (canceled)

3. The composition according to claim 1, wherein the acid is a saturated or unsaturated, branched or linear carboxylic acid with 40 or less carbon atoms (C≤40), such as methanoic acid, ethanoic acid, ethanedioic acid, oxoethanoic acid, 2-hydroxyethanoic acid, propanoic acid, prop-2-enoic acid, 2-propynoic acid, propanedioic acid, 2-hydroxypropanedioic acid, oxopropanedioic acid, 2,2-dihydroxypropanedioic acid, 2-oxopropanoic acid, 2-hydroxypropanoic acid, 3-hydroxypropanoic acid, 2,3-dihydroxypropanoic acid, 2-oxiranecarboxylic acid, butanoic acid, 2-methylpropanoic acid, 2-oxobutanoic acid, 3-oxobutanoic acid, 4-oxobutanoic acid, (E)-butenedioic acid, (Z)-butenedioic acid, But-2-ynedioic acid, oxobutanedioic acid, hydroxybutanedioic acid, 2,3-dihydroxybutanedioic acid, (E)-but-2-enoic acid, pentanoic acid, 3-methylbutanoic acid, pentanedioic acid, 2-oxopentanedioic acid, 3-oxopentanedioic acid, furan-2-carboxylic acid, tetrahydro-2-furancarboxylic acid, hexanoic acid, hexanedioic acid, 2-hydroxypropane-1,2,3-tricarboxylic acid, prop-1-ene-1,2,3-tricarboxylic acid, 1-hydroxypropane-1,2,3-tricarboxylic acid, (2E,4E)-hexa-2,4-dienoic acid, heptanoic acid, heptanedioic acid, cyclohexanecarboxylic acid, benzenecarboxylic acid, 2-hydroxybenzoic acid, octanoic acid, benzene-1,2-dicarboxylic acid, nonanoic acid, benzene-1,3,5-tricarboxylic acid, (E)-3-phenylprop-2-enoic acid, decanoic acid, decanedioic acid, undecanoic acid, dodecanoic acid, benzene-1,2,3,4,5,6-hexacarboxylic acid, tridecanoic acid, tetradecanoic acid, pentadecanoic acid, hexadecanoic acid, heptadecanoic acid, octadecanoic acid, (9Z)-octadec-9-enoic acid, (9Z,12Z)-octadeca-9,12-dienoic acid, (9Z,12Z,15Z)-octadeca-9,12,15-trienoic acid, (6Z,9Z,12Z)-octadeca-6,9,12-trienoic acid, (6Z,9Z,12Z,15Z)-octadeca-6,9,12,15-tetraenoic acid, nonadecanoic acid, eicosanoic acid, (5Z,8Z,11Z)-eicosa-5,8,11-trienoic acid, (5Z,8Z,11Z,14Z)-eicosa-5,8,11,14-tetraenoic acid, heneicosanoic acid, docosanoic acid, (4Z,7Z,10Z,13Z,16Z,19Z)-docosa-4,7,10,13,16,19-hexaenoic acid, tricosanoic acid, tetracosanoic acid, pentacosanoic acid, hexacosanoic acid, Carboceric acid, Montanic acid, Nonacosylic acid, Melissic acid, Hentriacontylic acid, Lacceroic acid, Psyllic acid, Geddic acid, Ceroplastic acid, Hexatriacontylic acid, Heptatriacontylic acid, Octatriacontylic acid, Nonatriacontylic acid, Tetracontylic acid, Myristoleic, Palmitoleic acid, Sapienic acid, Oleic acid, Elaidic acid, Vaccenic acid, Gadoleic acid, Eicosenoic acid, Erucic acid, Nervonic acid, Linoleic acid, Eicosadienoic acid, Docosadienoic acid, Tri-unsaturated fatty acids, Linolenic acid, Pinolenic acid, Eleostearic acid, Mead acid, Dihomo-γ-linolenic acid, Eicosatrienoic acid, Stearidonic acid, Arachidonic acid, Eicosatetraenoic acid, Adrenic acid, Pentaunsaturated fatty acids, Bosseopentaenoic acid, Eicosapentaenoic acid, Ozubondo acid, Sardine acid, Tetracosanolpentaenoic acid, Hexa-unsaturated fatty acids, Cervonic acid, Herring acid, ethanedioic acid, propanedioic acid, butanedioic acid, pentanedioic acid, hexanedioic acid, heptanedioic acid, octanedioic acid, nonanedioic acid, decanedioic acid, undecanedioic acid, dodecanedioic acid, tridecanedioic acid, hexadecanedioic acid, heneicosa-1,21-dioic acid, docosanedioic acid, triacontanedioic acid, (Z)-Butenedioic acid, (E)-Butenedioic acid, But-2-ynedioic acid, (Z)-Pent-2-enedioic acid, (E)-Pent-2-enedioic acid, 2-Decenedioic acid, Dodec-2-enedioic acid, Muconic acid, Glutinic acid, Citraconic acid, Mesaconic acid, Itaconic acid, 2-Hydroxypropanedioic acid, Oxopropanedioic acid, Hydroxybutanedioic acid, 2,3-Dihydroxybutanedioic acid, Oxobutanedioic acid, 2-Aminobutanedioic acid, 2-hydroxypentanedioic acid, 2,3,4-Trihydroxypentanedioic acid, 3-Oxopentanedioic acid, 2-Oxopentanedioic acid, 2-Aminopentanedioic acid, (2R,6S)-2,6-Diaminoheptanedioic acid, (2S,3S,4S,5R)-2,3,4,5-Tetrahydroxyhexanedioic acid, Benzene-1,2-dicarboxylic acid, Benzene-1,3-dicarboxylic acid, Benzene-1,4-dicarboxylic acid, 2-(2-Carboxyphenyl)benzoic acid, 2,6-Naphthalenedicarboxylic acid, pyruvic acid, oxaloacetic acid, acetoacetic acid, levulinic acid, benzoic acid, salicylic acid, ω-phenylalkanoic acid (x = 1 to 17), Bicyclic hexahydroindenoic acid, Crassinervic acid, glyceric acid, glycolic acid, lactic acid tartaric acid and Divinylether fatty acids.

4. (canceled)

5. The composition according to claim 1, wherein the amide is a polymeric amide selected from amidated polycarbohydrate such as amidated starch (amylose, amylopectine), cellulose, gums, chitosan and derivatives thereof, polypeptides, polynucleic acids and aliphatic polyamides such as Nylon 6, Nylon 6/6, Nylon 6/12, Nylon 11, Nylon 12, polyphthalamides, or aromatic polyamides.

6. The composition according to claim 1, wherein at least one amine is an amino acid with solubility of less than 20 g/100 mL in water at 25° C. and wherein said amino acid is preferably selected from at least one of Isoleucine, Tryptophan, Tyrosine, Leucine, Phenylalanine, Asparagine, Aspartic Acid, Glutamic Acid, Glutamine, Histidine, Methionine, Serine and Valine.

7. (canceled)

8. The composition according to claim 1, wherein the amine is a polymeric amine selected from at least one of aminated polycarbohydrate such as aminated starch (amylose, amylopectine), cellulose, gums, chitosan, and derivates thereof, polypeptides, polynucleic acid, poly(vinylpyridine), poly(vinylpyrrolidone), poly(vinylamine) and the salts, poly(L-lysine )and the salts, polyethylenimine and the salts, poly(allylamine) and the salts, poly(4-aminostyrene, poly(N-methylvinylamine), poly(diallyldimethyl) and the salts, poly(2-vinyl-1-methylpyridin) and the salts, Poly(N,N-dimethylaminoethyl methacrylate) [I], poly(N,N-dimethylaminoethylacrylate-co-methylmethacrylate) [II] and poly(N,N-dimethylaminopropylacrylamide-co-methylmethacrylate), polyoxypropylenediaminein.

9. The composition according to claim 1, wherein the amide is a primary amide according to formula I wherein X2 and X3 are hydrogen atoms and X1 contains less than 40 carbon atoms, wherein the carbon to nitrogen molar ratio is 40≥C/N≥ 6, and wherein said primary amide is not water soluble at a pH of 1 to 7 and wherein preferably said primary amide is selected from at least one of Erucamide, Oleamide, Behenamide, Stearamide, Palmitamide, Lauramide, 12-Hydroxystearamide and similar amides.

10. The composition according to claim 1, wherein the amide is a secondary organic amide according to formula I, wherein X2 is a hydrogen atom and X1 and X3 contain less than 40 carbon atoms each, wherein the carbon to nitrogen molar ratio of said secondary amide is 40≥C/N≥6, wherein said secondary amide is not water soluble at a pH of 1 to 7 and wherein -preferably said amide is selected from at least one of N-Stearyl stearamide, N-Stearyl oleamide, N-Oleyl stearamide, N-Stearyl erucamide, N-Methylolstearamide, Methylenebis stearamide, Ethylenebis capramide, Ethylenebis stearamide, Ethylenebis 12-hydroxystearamide, Ethylenebis behenamide, Hexamethylenebis stearamide, Hexamethylenebis behenamide, Hexamehylenebis 12-hydroxystearamide, N,N′-Distearyl adipamide, Ethylenebis oleamide, Hexamethylenebis oleamide, N,N′-Dioleyl adipamide, Oleyl Palmitamide, Stearyl Erucamide, Ethylene bis-Olemide and similar amides.

11. The composition according to claim 1, wherein the amide is a tertiary organic amide according to formula I wherein X1, X2 and X3 contain less than 40 carbon atoms each, wherein the carbon to nitrogen molar ratio of said tertiary amide is 40≥C/N≥ 6, wherein said tertiary amide is not water soluble at a pH of 1 to 7 and wherein preferably said amide is selected from at least one of N,N-Dimethyloleamide, N,N-Diethyl oleamide, Octadecanamide, N,N-bis(2-hydroxyethyl), N,N-Dimethylstearamide, N,N-bis(2-hydroxyethyl)stearamide, N,N-bis(2-hydroxyethyl)hexadecan-1-amide, N,N-bis(2-hydroxyethyl)oleamide, N,N-Bis(2-hydroxyethyl)dodecanamide and similar amides.

12. The composition according to claim 1, wherein the amine is a primary organic amine according to formula 11, wherein Y4 and Y5 are hydrogen atoms and Y1, Y2 and Y3 contain less than 50 carbon atoms each, wherein the primary amine has a carbon to nitrogen molar ratio of 40≥C/N≥ 6 and is not water soluble at a pH of 1 to 7 and wherein preferably said primary amine is selected from at least one of coco amine, oleylamine, tallow amine, soya amine, Stearyl amine, (12E,15E)-N-[(21E,24E)-hexatriaconta-21,24-dienyl]hexatriaconta-12,15-dien-1-amine, Dodecylamine and similar primary amines.

13. The composition according to claim 1, wherein the amine is a secondary organic amine according to formula 11, wherein Y5 is a hydrogen atom and Y1, Y2, Y3 and Y4 contain less than 50 carbon atoms each, wherein said secondary amine has a carbon to nitrogen molar ratio of 40≥C/N≥ 6 and is not water soluble at a pH of 1 to 7 and wherein preferably said secondary amine is selected from at least one of Dioleyl amine, Dioctadecylamine, (12E,15E)-N-[(21E,24E)-hexatriaconta-21,24-dienyl]hexatriaconta-12,15-dien-1-amine and similar secondary amines.

14. The composition according to claim 1, wherein the amine is a tertiary organic amine according to formula II, wherein Y1, Y2, Y3, Y4 and Y5 contain less than 50 carbon atoms each, wherein said tertiary organic amine has a carbon to nitrogen molar ratio of 40≥C/N≥ 6 and is not water soluble at a pH 1 to 7, and wherein preferably said tertiary amine is selected from at least one of: N-[3-(dimethylamino)propyl]dodecanamide, N-[3(Dimethylamino)propyl]myristamide, N-[3(dimethylamino)propyl]hexadecanamide, N-[3-(dimethylamino)propyl]octadecanamide, N-[3(dimethylamino)propyl]octadec-9-enamide,(9Z,12Z)-N-[3-(dimethylamino)propyl]octadeca-9,12-dienamide (linoleamide), (9Z,12Z,15Z)-N-[3-(dimethylamino)propyl]octadeca-9,12,15-trienamide (linolenamide) and N-[3-(dimethylamino)propyl]eicosanamide.

15. The composition according to claim 1, wherein at least one amine is a dimer diamine and wherein said dimer diamine is preferably a fatty dimer diamine with less than 50 carbon atoms, more preferably (12E,15E)-N-[(21E,24E)-hexatriaconta-21,24-dienyl]hexatriaconta-12,15-dien-1-amine and similar diamer diamines.

16. The composition according to claim 1, wherein the amide is synthesized from a fatty acid with less than 50 carbon atoms and is selected from at least one of, preferably oleyol palmitamide and stearyl erucamide, and wherein the amine is dimer diamine, wherein said dimer diamine is a preferably a fatty dimer diamine with less than 50 carbon atoms and is selected from at least one of ,-(12E,15E)-N-[(21E,24E)-hexatriaconta-21,24-dienyl]hexatriaconta-12,15-dien-1-amine and similar.

17. The composition according to claim 1, wherein the amide is synthesized from a fatty acid with less than 50 carbon atoms and is selected from at least one of, preferably oleyol palmitamide and stearyl erucamide,-chitosan.

18. The composition according to claim 1, further comprising a Lewis acid, selected from a salt solution of a Group 4 or group 13 metal salt and the mixture thereof and wherein said Lewis acid is selected from at least one of,-Zirconium acetate and/or Zirconium acetate hydroxide.

19. An emulsified liquid composition comprising:
a) 0.01 to 50 wt% of a hydrophobic phase;
b) 0.01 to 12 wt% of an emulsifying composition according to claim 1;
c) 38 to 99.98 wt% of water; and
d) optionally at least one of a defoamer, a coalescent agent, a preservative, a co-emulsifier, chain extender, crosslinker and a rheology modifier.

20. (canceled)

21. The emulsified liquid composition according to claim 19, wherein the hydrophobic phase comprises one or more hydrophobic agents which are independently of each other selected from the group consisting of natural oil, synthetic oil, natural wax, synthetic waxes, liquid resin, fatty acid, fatty alcohol, fatty silane, fatty siloxane, fatty epoxide, fatty imine, fatty aldehyde, fatty imide, fatty thiol, fatty sulfate, fatty ester, fatty ketone, other types of lipids.

22. (canceled)

23. (canceled)

24. (canceled)

25. The emulsified liquid composition according to claim 19, comprising
a) 0.2 to 30 wt% of the hydrophobic phase;
b) 0.1 to 8 wt% of the emulsifying composition, wherein the selected Lewis acid is zirconium acetate in amounts of 0.1 to 5 wt%, and
c) optionally 0.1 to 3 wt%, said co-surfactant, 0.5 to 3 wt% of said coalescent agent, 0.005 to 0.5 wt% of said preservative.

26. A method of enhancing the water repellency of an inorganic, organic or fiber based materials and/ or enhancing the treated material’s ability to repel water soluble dirt, comprising:
a) adding a composition according to claim 19 to said inorganic, organic or fiber based material;
b) optionally adjusting the amount of composition applied to said material;
c) drying the treated inorganic, organic or fiber based materials until substantially dry; and
d) optionally curing the treated inorganic, organic or fiber based materials at a temperature of between 10 to 200° C.

27. The composition according to claim 1, wherein the molar ratio of carbon atoms to nitrogen atoms of said at least one amide is 60≥C/N≥5 and wherein the molar ratio of carbon atoms to nitrogen atoms of said at least one amine is 60≥C/N≥5.
